(19) United States
(12) Patent Application Publication
(10) Pub. No.: US 2026/0087856 A1
(43) Pub. Date: Mar. 26, 2026

(54) IDENTIFICATION REGISTRATION METHOD AND IDENTIFICATION REGISTRATION DEVICE

(71) Applicant: REALTEK SEMICONDUCTOR CORPORATION, HSINCHU (TW)

(72) Inventors: DONG-SHENG LIANG, HSINCHU (TW); HAN-YANG WANG, HSINCHU (TW); SZU-PO HUANG, HSINCHU (TW); SHIH-TSE CHEN, HSINCHU (TW); CHIEN-HAO CHEN, HSINCHU (TW)

(21) Appl. No.: 19/333,618

(22) Filed: Sep. 19, 2025

(30) Foreign Application Priority Data
Sep. 23, 2024 (TW) 113136025

(51) Int. Cl. G06V 40/50; G06F 21/45; G06N 3/063; G06V 40/16; H04N 23/65

(52) U.S. Cl. CPC G06V 40/50; G06F 21/45; G06N 3/063; G06V 40/161; H04N 23/651; G06F 2221/2117

(57) ABSTRACT

An identification registration method executed by a processor reading at least command stored in a memory is disclosed herein. The identification registration method includes following steps: when an identification registration of a biometric login of an operation system begins, transmitting an activation command to an image capturing device; capturing a plurality of first images according to the activation command by the image capturing device; executing a first image processing to the plurality of first images to obtain a first biometric feature by a neural processor of the image capturing device; and registering the first biometric feature in a flash memory by the neural processor of the image capturing device.

### BACKGROUND OF THE INVENTION

### 1. Field of the Invention

The present disclosure relates to an identification registration method and an identification registration device, especially to an identification registration method and an identification registration device that can effectively assist in identifying a visitor's identity to facilitate visitor login.

### 2. Description of Related Art

A computer can detect whether a visitor is approaching it by using a time of flight (TOF) sensor to determine whether to wake up the computer. However, the measurement range of the TOF sensor is limited. If the distance between the visitor and the TOF sensor is too great, the measurement accuracy and reliability of the TOF sensor will decrease, preventing it from accurately identifying the visitor. As a result, even if the visitor is an authorized user of the computer, the authorized user may be unable to log in properly.

### SUMMARY OF THE INVENTION

In some aspects, an object of the present disclosure is to, but not limited to, provides an identification registration method and an identification registration device that make an improvement to the prior art.

An embodiment of an identification registration method of the present disclosure, which is executed by a processor reading at least one command stored in a memory, includes following steps: when an identification registration of a biometric login of an operation system begins, transmitting an activation command to an image capturing device; capturing a plurality of first images by the image capturing device according to the activation command; executing a first image processing to the plurality of first images by a neural processor of the image capturing device to obtain a first biometric feature; and registering the first biometric feature in a flash memory by the neural processor of the image capturing device.

An embodiment of an identification registration device of the present disclosure includes a memory and a processor. The memory is configured to store at least one command. The processor is configured to read the at least one command to execute following steps: when an identification registration of a biometric login of an operation system begins, transmitting an activation command to an image capturing device; capturing a plurality of first images by the image capturing device according to the activation command; executing a first image processing to the plurality of first images by a neural processor of the image capturing device to obtain a first biometric feature; and registering the first biometric feature in a flash memory by the neural processor of the image capturing device.

Technical features of some embodiments of the present disclosure make an improvement to the prior art. The identification registration method and the identification registration device of the present disclosure utilize an image capturing device to capture images, thereby effectively assisting in identifying a visitor's identity to facilitate visitor login. Additionally, when the identification registration of the biometric login of the operation system begins, the identification registration method of the present disclosure can be executed simultaneously. Therefore, a user does not need to perform a separate registration process specifically for the present disclosure, enabling convenient registration of the biometric feature of the user into the flash memory through the identification registration method of the present disclosure. Furthermore, since the present disclosure only requires the neural processor of the image capturing device to execute image processing without utilizing the processor of the identification registration device, it can effectively conserve the performance of the identification registration device.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of an identification registration device of the present disclosure.

FIG. 2 shows an embodiment of a flow diagram of an identification registration method of the present disclosure.

### DETAILED DESCRIPTION OF THE PREFERRED EMBODIMENTS

To address the issue that existing sensors fail to effectively identify a visitor's identity due to long distances, thereby preventing the visitor from successfully logging into an electronic device, the present disclosure provides an identification registration method and an identification registration device, which will be explained in detail as shown below.

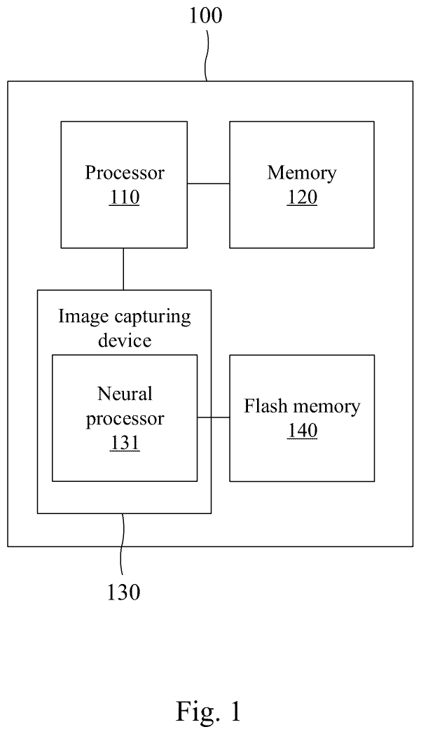

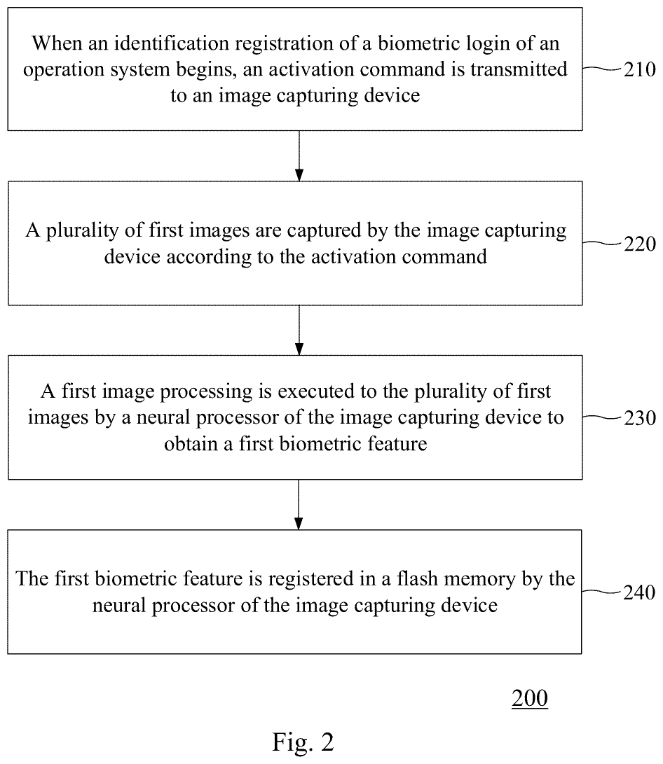

FIG. 1 shows an embodiment of an identification registration device 100 of the present disclosure. As shown in the figure, the identification registration device 100 includes a processor 110, a memory 120, an image capturing device 130, and a flash memory 140. Besides, the image capturing device 130 includes a neural processor (e.g., Neural Processing Unit, NPU) 131. The memory 120 can be a dynamic random-access memory (DRAM), and the memory 120 is configured to store at least one command. The processor 110 is configured to read the at least one command to execute an identification registration process. For facilitating the understanding of operations of the identification registration device 100, reference is made to FIG. 2. FIG. 2 shows an embodiment of a flow diagram of an identification registration method 200 of the present disclosure.

In step 210, when an identification registration of a biometric login of an operation system begins, an activation command is transmitted to an image capturing device. For example, when a user intends to execute an identification registration, the user will enter a screen of the biometric login of the operation system (e.g., Windows Hello of the Windows operation system) and select “begin executing the identification registration.” When the identification registration of the biometric login of the operation system (e.g., Windows Hello of the Windows operation system) begins, the processor 110 transmits an activation command (e.g., an extension unit command with metadata information) to the image capturing device 130 (e.g., a camera).

In step 220, a plurality of first images are captured by the image capturing device according to the activation command. For example, the image capturing device 130 (e.g., a camera) may capture a plurality of images (e.g., images including a human face) according to the activation command.

In step 230, a first image processing is executed to the plurality of first images by a neural processor of the image capturing device to obtain a first biometric feature. For example, the neural processor 131 of the image capturing device 130 (e.g., a camera) executes an image processing (e.g., image training) to the images (e.g., images including a human face) to obtain biometric features (e.g., face features).

In step 240, the first biometric feature is registered in a flash memory by the neural processor of the image capturing device. For example, the neural processor 131 of the image capturing device 130 (e.g., a camera) registers the biometric features (e.g., face features) in the flash memory 140.

As described above, overall, the identification registration device 100 and the identification registration method 200 of the present disclosure utilize the image capturing device 130 (e.g., a camera) to capture images. The neural processor 131 of the image capturing device 130 executes an image processing (e.g., image training) to the captured images (e.g., images including a human face) to obtain biometric features (e.g., face features) and execute registration. Consequently, the present disclosure can effectively assist in identifying a visitor's identity to facilitate visitor login.

Besides, when the identification registration of the biometric login of the operation system (e.g., Windows Hello of the Windows operation system) begins, the present disclosure can execute the identification registration method 200 through a background resident program of the identification registration device 100 (e.g., a computer) to detect the identification registration process that executes the biometric login (e.g., Windows Hello). The identification registration method 200 can be executed simultaneously. As a result, a user does not need to execute a separate registration process specifically for the present disclosure, enabling convenient registration of the biometric feature of the user into the flash memory 140 through the identification registration method 200 of the present disclosure.

Furthermore, since the present disclosure only requires the neural processor 131 of the image capturing device 130 (e.g., a camera) to execute image processing without utilizing the processor 110 of the identification registration device 100, it can effectively conserve the performance of the identification registration device 100 (e.g., a computer).

In some embodiments, the identification registration method 200 further includes the following steps: controlling the operation system to enter a sleep mode; continuously capturing a plurality of second images by the image capturing device during the sleep mode; executing a second image processing to the plurality of second images by the neural processor of the image capturing device to obtain a second biometric feature; determining whether the second biometric feature matches the first biometric feature by the neural processor of the image capturing device; and if the second biometric feature does not match the first biometric feature, do not wake up the operation system. For example, when a user leaves the identification registration device 100 (e.g., a computer), the operation system (e.g., the Windows operation system) will automatically enter a sleep mode. The image capturing device 130 (e.g., a camera) continuously captures images in the sleep mode. If a visitor approaches the identification registration device 100 (e.g., a computer) at this time, the image capturing device 130 (e.g., a camera) captures an image including the visitor.

Next, the neural processor 131 of the image capturing device 130 (e.g., a camera) executes image processing (e.g., image training) to the image including the visitor to obtain the biometric feature of the visitor (e.g., the face feature of the visitor). Subsequently, the neural processor 131 of the image capturing device 130 (e.g., a camera) determines whether the biometric feature of the visitor (e.g., the face feature of the visitor) matches the registered biometric feature stored in the flash memory 140 (e.g., the face feature of the user). If the biometric feature of the visitor (e.g., the face feature of the visitor) does not match the registered biometric feature (e.g., the face feature of the user), the operation system is not woken up. In this way, when the visitor is not a registered user, the present disclosure will not wake up the operation system, thereby achieving the purposes of power saving and privacy protection.

In some embodiments, the identification registration method 200 further includes the following steps: if the second biometric feature matches the first biometric feature, wake up the operation system. For example, when a user leaves the identification registration device 100 (e.g., a computer), the operation system (e.g., the Windows operation system) automatically enters a sleep mode. If a visitor approaches the identification registration device 100 (e.g., a computer) at this time, and the biometric feature of the visitor (e.g., the face feature of the visitor) matches the registered biometric feature (e.g., the face feature of the user), the operation system is woken up. In this way, when a visitor is a registered user, the present disclosure immediately wakes up the operation system, achieving power saving and privacy protection.

In some embodiments, the step 230 in FIG. 2 includes: determining whether the plurality of first images include a frontal face image by the neural processor of the image capturing device; and if a plurality of target images of the plurality of first images include the frontal face image, executing the first image processing to the plurality of target images by the neural processor of the image capturing device to obtain the first biometric feature. For example, to ensure the accuracy of the information, the neural processor 131 of the image capturing device 130 (e.g., a camera) determines whether the captured image is a frontal face image. If the captured image is a frontal face image, the neural processor 131 of the image capturing device 130 (e.g., a camera) then executes image processing to obtain the face feature. If the captured image is not a frontal face image, the present disclosure does not execute image processing. For example, if the captured image is a side face image, it is difficult to accurately obtain all face features from the side face image. Therefore, the present disclosure does not execute image processing to ensure the accuracy of the information.

In some embodiments, the step 240 in FIG. 2 includes: when the identification registration of the biometric login of the operation system ends, transmitting an end command to the image capturing device; and registering the first biometric feature in the flash memory by the neural processor of the image capturing device according to the end command. For example, when the identification registration of the biometric login of the operation system (e.g., Windows Hello of the Windows operation system) ends, the processor 110 transmits an end command to the image capturing device 130 (e.g., a camera). Subsequently, the neural processor 131 of the image capturing device 130 (e.g., a camera) registers the biometric feature in the flash memory 140 according to the end command as a basis for subsequent identity authentication and login determination.

It should be noted that the present disclosure is not limited to the embodiments as shown in FIG. 1 to FIG. 2, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The identification registration method and the identification registration device of the present disclosure utilize an image capturing device to capture images, thereby effectively assisting in identifying a visitor's identity to facilitate visitor login. Additionally, when the identification registration of the biometric login of the operation system begins, the identification registration method of the present disclosure can be executed simultaneously. Therefore, a user does not need to perform a separate registration process specifically for the present disclosure, enabling convenient registration of the biometric feature of the user into the flash memory through the identification registration method of the present disclosure. Furthermore, since the present disclosure only requires the neural processor of the image capturing device to execute image processing without utilizing the processor of the identification registration device, it can effectively conserve the performance of the identification registration device.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An identification registration method, executed by a processor reading at least command stored in a memory, comprising:
when an identification registration of a biometric login of an operation system begins, transmitting an activation command to an image capturing device;
capturing a plurality of first images by the image capturing device according to the activation command;
executing a first image processing to the plurality of first images by a neural processor of the image capturing device to obtain a first biometric feature; and
registering the first biometric feature in a flash memory by the neural processor of the image capturing device.

2. The identification registration method of claim 1, further comprising:
controlling the operation system to enter a sleep mode;
continuously capturing a plurality of second images by the image capturing device during the sleep mode;
executing a second image processing to the plurality of second images by the neural processor of the image capturing device to obtain a second biometric feature;
determining whether the second biometric feature matches the first biometric feature by the neural processor of the image capturing device; and
if the second biometric feature does not match the first biometric feature, do not wake up the operation system.

3. The identification registration method of claim 2, further comprising:
if the second biometric feature matches the first biometric feature, wake up the operation system.

4. The identification registration method of claim 1, wherein executing the first image processing to the plurality of first images by the neural processor of the image capturing device to obtain the first biometric feature comprises:
determining whether the plurality of first images comprise a frontal face image by the neural processor of the image capturing device; and
if a plurality of target images of the plurality of first images comprise the frontal face image, executing the first image processing to the plurality of target images by the neural processor of the image capturing device to obtain the first biometric feature.

5. The identification registration method of claim 1, wherein registering the first biometric feature in the flash memory by the neural processor of the image capturing device comprises:
when the identification registration of the biometric login of the operation system ends, transmitting an end command to the image capturing device; and
registering the first biometric feature in the flash memory by the neural processor of the image capturing device according to the end command.

6. An identification registration device, comprising:
a memory, configured to store at least one command; and
a processor, configured to read the at least one command to execute following steps:
when an identification registration of a biometric login of an operation system begins, transmitting an activation command to an image capturing device;
capturing a plurality of first images by the image capturing device according to the activation command;
executing a first image processing to the plurality of first images by a neural processor of the image capturing device to obtain a first biometric feature; and
registering the first biometric feature in a flash memory by the neural processor of the image capturing device.

7. The identification registration device of claim 6, wherein the processor is further configured to read the at least one command to execute following steps:
controlling the operation system to enter a sleep mode;
continuously capturing a plurality of second images by the image capturing device during the sleep mode;
executing a second image processing to the plurality of second images by the neural processor of the image capturing device to obtain a second biometric feature;
determining whether the second biometric feature matches the first biometric feature by the neural processor of the image capturing device; and
if the second biometric feature does not match the first biometric feature, do not wake up the operation system.

8. The identification registration device of claim 7, wherein the processor is further configured to read the at least one command to execute following steps:
if the second biometric feature matches the first biometric feature, wake up the operation system.

9. The identification registration device of claim 6, wherein executing the first image processing to the plurality of first images by the neural processor of the image capturing device to obtain the first biometric feature which is executed by the processor comprises:
determining whether the plurality of first images comprise a frontal face image by the neural processor of the image capturing device; and
if a plurality of target images of the plurality of first images comprise the frontal face image, executing the first image processing to the plurality of target images by the neural processor of the image capturing device to obtain the first biometric feature.

10. The identification registration device of claim 6, wherein registering the first biometric feature in the flash memory by the neural processor of the image capturing device which is executed by the processor comprises:
when the identification registration of the biometric login of the operation system ends, transmitting an end command to the image capturing device; and
registering the first biometric feature in the flash memory by the neural processor of the image capturing device according to the end command.
